(19) United States
(12) Patent Application Publication
(10) Pub. No.: US 2002/0184052 A1
(43) Pub. Date: Dec. 5, 2002

(54) Method of providing an elective organization providing premium health services for members of the organization

(76) Inventor: Matthew A. Parker, Washington, DC (US)

Correspondence Address: STAAS & HALSEY LLP, 700 11TH STREET, NW, SUITE 500, WASHINGTON, DC, 20001, US

(21) Appl. No.: 09/873,300

(22) Filed: Jun. 5, 2001

(51) Int. Cl. G06F 17/60

(52) U.S. Cl. 705/2

(57) ABSTRACT

A method for a providing an elective organization that provides premium health services for people choosing to become a member of the organization. The method comprises (a) associating a plurality of doctors in various locations with an organization, the associated doctors being selected by the organization based on each doctor's respective credentials; and (b) charging a membership fee to allow a plurality of members to belong to the organization, the members being permitted to seek any number of visits with any of the associated doctors in any of the various locations, herein the organization does not provide health insurance, but provides additional medical care regardless of any health insurance a member may already possess.

### FIELD OF THE INVENTION

The present invention provides for a providing an elective organization that provides premium health services for people choosing to become a member of the organization. More particularly, the present invention allows members who choose to belong to the organization various benefits, including providing instant doctor visits to members regardless of the member's current location. Furthermore, the financial transactions related to the organization can be executed by a credit card company, therefore relieving the parties involved with the collection of funds.

### BACKGROUND OF THE INVENTION

Many frequent travelers find themselves needing to visit a doctor in a different location from their residence. Unfortunately, there is no easy way for these travelers to obtain the same level of medical care in such foreign locations, as their family doctor and primary health care practitioners are far away.

These unfortunate travelers have a few ways to visit a physician in a foreign location. One option they have is they can visit the emergency room of a local hospital. However, such an option is less than desirable, as the patient typically must wait a long period of time before he/she is able to visit with a physician, especially if the physical ailment is not an emergency. Further, the doctor that the patient will typically be assigned to will not be an expert in the specialty the patient desires. Further, a high percentage of emergency room doctors are less-experienced doctors undergoing their residency. In addition, the traveler will have to pay the medical bills for this visit.

Another option a traveler has is to consult a director such as the phone book and pick a private practitioner at random. However, this method is also less desirable, as most private practitioners have busy schedules and are not available to meet with a new patient instantaneously or even in the next few days. Further, if the traveler desires a visit after normal office hours, it is extremely unlikely that he will be able to find a private practitioner he is not acquainted with to make a special appointment. Additionally, private practitioners are not keen about meeting with patients from other locations, as the private practitioner knows that he will likely never see the patient again, and thus may not give him the attention and/or consideration the private practitioner would normally give their long term patients. The traveler will also be responsible for paying the medical bills if he/she is lucky enough to procure an appointment with a physician.

The traveler's health insurance may also have an association with doctors in various locations. Thus, if the traveler is lucky, his health insurance may allow him to visit a hospital or private practitioner in another location. However, these options are less than ideal for the reasons stated above. That is, visiting a hospital will typically result in a very long wait to finally meet with a less experienced doctor. Even if the traveler's health insurance allows him to visit with a private practitioner in the foreign city, as stated above the private practitioner will typically not be enthusiastic to meet with this patient and may be difficult if not impossible to schedule an appointment with during the traveler's time in the foreign city.

Further, if the traveler finds himself in a foreign country, the above problems become exasperated. Most health insurance policies in the U.S. do not even cover doctors in foreign countries. Moreover, medical care in most foreign countries is typically inferior to the standards maintained in the U.S.

Because of the above problems with obtaining adequate medical care in foreign locations, if a traveler needs to see a physician for a nontrivial matter he/she may likely fly home to see his primary physician(s). The airlines even recognize this problem and some offer special medical emergency fares for travelers needing to fly home without advance purchase.

Therefore, what is needed is a system whereby a traveler can travel across the country, and even in foreign countries, and have the ability to visit with a highly qualified physician immediately no matter where he/she may be.

### OBJECTS OF THE INVENTION

Objects of the present invention include providing a person belonging to an organization with premium health care services regardless of the person's location.

The foregoing objects of the present invention are obtained by a system (a) associating a plurality of doctors in various locations with an organization, the associated doctors being selected by the organization based on each doctor's respective credentials; (b) charging a membership fee to allow a plurality of members to belong to the organization, the members being permitted to seek any number of visits with any of the associated doctors in any of the various locations, wherein the organization does not provide health insurance, but provides additional medical care regardless of any health insurance a member may already possess.

### BRIEF DESCRIPTION OF THE DRAWINGS

The details of the invention will become apparent and more readily appreciated from the following description of the preferred embodiments, taken in conjunction with the accompanying drawings, of which:

FIG. 1 is a flowchart illustrating one method of implementing the present invention, according to an embodiment of the invention; and

FIG. 2 is a geographical block diagram illustrating one embodiment of the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

The present invention is a method which allows an organization to provide preferred patient services to members choosing to belong to the organization. Members typically pay an annual fee for the privilege to belong to the organization.

The membership fee to the organization can be unsubsidized. This is in contrast to typical health insurance plans which have subsidized pricing structures. A subsidized pricing structure is one where patients typically pay the same price, regardless of their medical situation. For example, a person with a serious medical disorder requiring more medical costs than a healthy person nevertheless typically both pay the same health insurance premiums. Thus the people requiring more medical costs “balance out” the people requiring less medical costs. In contrast to a subsidized pricing structure, in an unsubsidized pricing structure one member of the organization who has been determined to require more medical costs can pay a higher cost than a member who generally requires less medical costs.

The organization also chooses doctors which are associated with the organization. The doctors chosen are typically those that the organization concludes have outstanding credentials and will be an asset to the organization. The doctors chosen can also include a preexisting network of doctors. For example, a network of doctors may exist in a particular city. The organization may choose to have this entire local network of doctors belong to the organization. The doctors chosen are typically private practitioners, i.e., they are not affiliated with any public organization or health insurance.

Typically, the doctors associated with the organization also agree to provide premium services to the members of the organization. Thus, the associated doctors should typically make every effort to see a member immediately, without having the member wait.

Each member will typically be given a list of associated doctors in which he/she can visit with. Additionally, a current list of associated doctors can be made available on a computer communications network, such as the Internet. Also, a toll free number may be available for members to call to inquire about associated doctors.

When a member of the organization is away from home and desires to see a doctor, he may seek an immediate visit any doctor associated with the organization in his current location. The member will also be typically given “extra special” treatment by the doctor he visits with.

A doctor associated with the organization can typically receive a member's medical records through the organization. The organization may request medical records from each member's previous doctors so the organization can store them. The organization may also make these records accessible via a computer communications network such as the Internet. Thus, an associated doctor upon seeing a member without advance notice, may immediately download the member's medical records. Further, when an associated doctor has completed an appointment with a member, the doctor may upload the records from the visit back to the organization. Thus, the organization maintains a complete up to date database of each member's records.

In addition, financial transactions involving the organization can be processed through a credit card company. The annual fee paid by each member can be paid via each member's credit card. The annual fee can automatically be charged to the member's account each year. The credit card company, in turn, can pay the full annual fee to the actual organization. Alternatively, the credit card company may choose to become affiliated with (or even own) the organization. In that case, the credit card company may keep part or all of the annual fee. Any remaining amount not kept by the credit card company may get paid to the actual organization itself.

Each associated doctor is compensated for each appointment with a member of the organization. Thus, if a member completes an appointment with an associated doctor, that doctor will receive compensation by the organization for the visit. The doctor can receive a credit or check from the credit card company for each visit, instead of receiving it from the organization itself. Receiving compensation by the credit card company directly may be preferred by the associated doctors, as they do not have to depend on the integrity of the organization itself to ensure payment for each visit is promptly received. Further, the compensation paid to the doctor can be set by the organization to be a universally fixed amount for each visit (plus associated medical costs such as lab tests, etc.) regardless of the circumstances. In the alternative, the compensation can vary according to time and/or effort the doctor spent on the particular visit.

Thus, note that organization does not provide “health insurance,” but provides an additional service on top of any health insurance each member may already possess. Typically, the annual fee for each individual member and per visit compensation for each doctor will be set so that the organization can run at a profit. Annual fees for each member, as stated above, need not be identical for each member. Also, per visit compensation for each doctor need not be identical for each doctor. The organization can adjust these fees to maximize profits. Further, typically the doctors associated with the organization are private practitioners.

Further, the organization can be marketed by a credit card company. The credit card company can send out targeted mailings to its customers that they think may benefit from belonging to the organization. Typically, people who would benefit from belonging to the organization would be those who have high incomes and travel frequently. Therefore, the credit card company may examine its records and send out brochures to those customers who it can identify as high income individuals. The credit card company may have an individuals income on file. Additionally, those customers who charge a lot on their credit card may be identified as high income. Further, those customers who are identified as purchasing travel items frequently (i.e., airline tickets, hotels) are also identified as potential candidates to market the organization to. Credit card companies typically maintain sophisticated databases of their customers characteristics, including purchasing habits. To query the database to identify customers with the purchasing characteristics mentioned above would be easily accomplished, presumably by the marketing department of the credit card company. Because a credit card company may have a reputable name, potential members of the organization may choose to belong to the organization because of its affiliation or sponsorship by the credit card company itself.

Further, the organization may maintain doctors internationally as well as throughout the United States. Associating doctors in foreign countries is especially valuable to international travelers, as high quality medical care in foreign countries may be difficult to find.

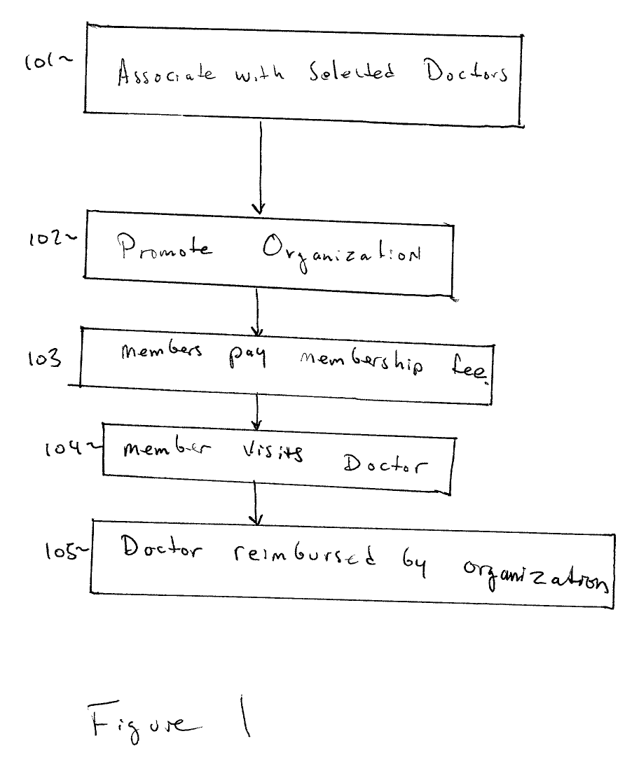

FIG. 1 is a flowchart illustrating one method of implementing the present invention. It can be appreciated that numerous variations of this approach can be taken.

Referring now to FIG. 1, in operation 101, the organization associates with selected doctors. The association/selection of doctors can be performed as described above, or using any other known method that doctors can be selected.

From operation 101, the method proceeds to operation 102, wherein the organization is promoted to potential members. The promotion can be performed as described above, or by using any other type of business promotion method.

From operation 102, the method proceeds to operation 103, wherein members who decide to enroll pay a membership fee. As discussed above, the membership fee can be paid to the organization or a sponsor of the organization, such as a credit card company.

From operation 103, the method proceeds to operation 104, wherein a traveling member calls upon and visits with one of the selected doctors.

From operation 104, the method proceeds to operation 105, wherein the visited doctor then receives reimbursement from the organization, or the organization's sponsor.

The sequence operations 101-105 does not have to be sequential, but typically each of the above operations can be performed in any sequence (except of course that operation 105 should typically follow operation 104, as each visited doctor should be compensated for the visit).

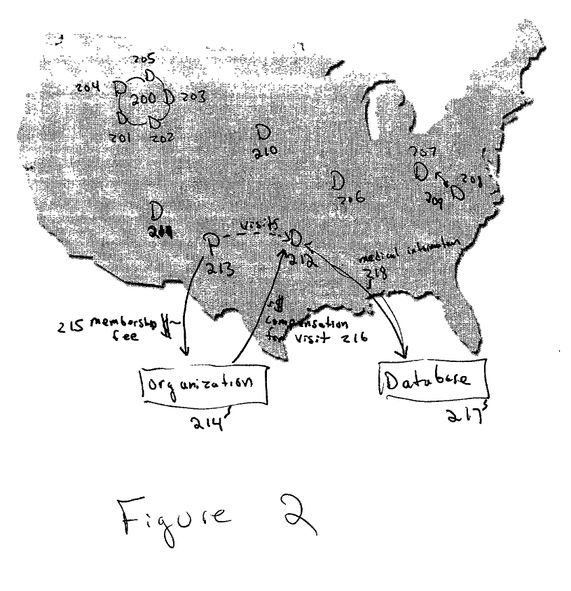

FIG. 2 is a geographical block diagram illustrating one embodiment of the present invention. While FIG. 2 illustrates a map of the United States for simplicity, the present invention is not limited to the United States but can be applied throughout the entire world.

In FIG. 2, the letter D represents doctors located around the country, and P represent patients. Doctors 201, 202, 203, 204, 205 belong to a pre-existing network of doctors 200. Thus the pre-existing network of doctors 200 has decided to affiliate with the organization. Doctors 207 and 208 also belong to a pre-existing network or group of two doctors 209. Other doctors pictured are 206, 210, 211, 212.

Patient 213 belongs to the organization 214 which includes paying a membership fee 215. If patient 213 visits doctor 212, patient 213 typically pays nothing to doctor 212 (except for costs not covered by the organization for example medications, lab tests, etc.) The organization 214 compensates doctor 212 by paying him compensation for the visit.

A database 217 can be maintained by the organization with medical records for members of the organization 214. Thus, doctor 212 can receive patient 213 medical records via a communication of medical information 218. Doctor 212 can also send his records regarding patient 213 back to the database 217. The communication of medical information can be accomplished by any communication methods, including a computer communications network such as the Internet, fax, mail, etc.

Note that the organization 214 can actually be a credit card company which handles the financial transactions. The credit card company can then transact separately with the organization sponsoring the method of the present invention. For example, the credit card company may have to pay royalties to the organization for maintaining the association of doctors.

Therefore, as a result of the above-described invention, a person who finds himself away from home and needing to visit a doctor can actually see a doctor quickly without having to wait an unreasonable time for an appointment.

Although a few preferred embodiments of the present invention have been shown and described it would be appreciated by those skilled in the art that changes may be made in these embodiments without departing from the principles and spirit of the invention, the scope of which is defined in the claims and their equivalents.

What is claimed is:

1. A method of providing preferred patient services, comprising:
associating a plurality of doctors in various locations with an organization, the associated doctors being selected by the organization based on each doctor's respective credentials; and
charging a membership fee to allow a plurality of members to belong to the organization, the members being permitted to seek any number of visits with any of the associated doctors in any of the various locations,
wherein the organization does not provide health insurance, but provides additional medical care regardless of any health insurance a member may already possess.

2. A method as recited in claim 1, wherein the organization is promoted through a credit card company.

3. A method as recited in claim 2, wherein the credit card company offers membership to the organization to a potential member based on purchasing characteristics of the potential member.

4. A method as recited in claim 3, wherein the purchasing characteristics of the potential member comprises frequent travel.

5. A method as recited in claim 3, wherein the purchasing characteristics of the potential member comprises frequent international travel.

6. A method as recited in claim 3, wherein the purchasing characteristics of the potential member comprises high spending.

7. A method as recited in claim 3, wherein the purchasing characteristics of the potential member comprises a high income.

8. A method as recited in claim 1, wherein the various locations comprise various cities.

9. A method as recited in claim 1, wherein the various locations comprise various countries.

10. A method as recited in claim 1, wherein the selected doctors comprises a preexisting network of doctors.

11. A method as recited in claim 1, wherein a member can access a list of the selected doctors and identify a doctor in a particular location by using the Internet.

12. A method as recited in claim 1, wherein a member can access a list of the selected doctors via a toll free telephone number.

13. A method as recited in claim 1, wherein the selected doctors possess excellent credentials, as judged by the organization.

14. A method as recited in claim 1, wherein the associated doctors pay a fee to be associated with the organization.

15. A method as recited in claim 1, wherein the visit a member seeks with an associated doctor is provided immediately.

16. A method as recited in claim 1, wherein an associated doctor shares medical information regarding a member of the organization with other associated doctors using the Internet.

17. A method as recited in claim 1, wherein the organization can import and store a member's medical records from the member's regular doctor or primary health care provider.

18. A method as recited in claim 1, wherein the members pay the membership fee to a credit card company.

19. A method as recited in claim 18, wherein the credit card company pays an associated doctor for conducting a visit with a member of the organization.

20. A method as recited in claim 1, wherein the membership fee is non-subsidized.

21. A method as recited in claim 1, wherein the associated plurality of doctors are private practitioners.

22. A method of providing preferred patient services, comprising:
associating a plurality of doctors in various locations with an organization, the associated doctors being selected by the organization based on each doctor's respective credentials; and
charging a membership fee to allow a plurality of members to belong to the organization, the members being permitted to seek any number of visits with any of the associated doctors in any of the various locations,
wherein the organization does not provide health insurance, but provides additional medical care regardless of any health insurance a member may already possess,
wherein the organization is promoted through a credit card company,
wherein the credit card company offers membership to the organization to a potential member based on purchasing characteristics of the potential member,
wherein the purchasing characteristics of the potential member comprises frequent travel,
wherein the purchasing characteristics of the potential member comprises frequent international travel,
wherein the purchasing characteristics of the potential member comprises high spending,
wherein the purchasing characteristics of the potential member comprises a high income,
wherein the various locations comprise various cities,
wherein the various locations comprise various countries,
wherein the selected doctors comprises a preexisting network of doctors,
wherein a member can access a list of the selected doctors and identify a doctor in a particular location by using the Internet,
wherein a member can access a list of the selected doctors via a toll free telephone number,
wherein the selected doctors possess excellent credentials, as judged by the organization,
wherein the associated doctors pay a fee to be associated with the organization,
wherein the visit a member seeks with an associated doctor is provided immediately,
wherein an associated doctor shares medical information regarding a member of the organization with other associated doctors using the Internet,
wherein the organization can import and store a member's medical records from the member's regular doctor or primary health care provider,
wherein the members pay the membership fee to a credit card company,
wherein the credit card company pays an associated doctor for conducting a visit with a member of the organization,
wherein the membership fee is non-subsidized,
wherein the associated plurality of doctors are private practitioners.

23. A method of providing preferred patient services, comprising:
associating a plurality of doctors in various locations with an organization, the associated doctors being selected by the organization based on each doctor's respective credentials; and
charging a membership fee to allow a plurality of members to belong to the organization, the members being permitted to seek any number of visits with any of the associated doctors in any of the various locations,
wherein the organization does not provide health insurance, but provides additional medical care regardless of any health insurance a member may already possess,
wherein the member pay the membership fee to a credit card company,
wherein the credit card company pays an associated doctor for conducting a visit with a member of the organization,
wherein an associated doctor shares medical information regarding a member of the organization with other associated doctors using the Internet.
